(19) United States
(12) Patent Application Publication
(10) Pub. No.: US 2004/0124044 A1
(43) Pub. Date: Jul. 1, 2004

(54) Compact braked rolling bearing

(75) Inventor: Franck Landrieve, Fondettes (FR)

Correspondence Address: YOUNG & THOMPSON, 745 SOUTH 23RD STREET 2ND FLOOR, ARLINGTON, VA, 22202

(73) Assignee: AKTIEBOLAGET SKF, GOTEBORG (SE)

(21) Appl. No.: 10/735,634

(22) Filed: Dec. 16, 2003

(30) Foreign Application Priority Data
Dec. 17, 2002 (FR) 02 16022

(51) Int. Cl. F16D 65/10

(52) U.S. Cl. 188/218 R

(57) ABSTRACT

Braked rolling bearing device of the kind for a control wheel, comprising an outer part and an inner part, one being able to rotate with respect to the other, which does not rotate, via at least one row of rolling elements arranged between the rotating and non-rotating parts, the device further comprising an element for detecting rotation parameters and an element for braking the rotating part. The braking element comprises at least one component equipped with flexible tabs bearing against an annular friction member.

The present invention relates to the field of instrumented assemblies of the kind for operating wheels used, for example, to steer motor vehicles, handling equipment or civil engineering works equipment or any other type of equipment or machine requiring a control wheel.

Conventionally, a control wheel is connected to a shaft, for example a steering column shaft which, depending on the type of steering used, directly turns the steering mechanism in the case of a mechanical steering system, actuates hydraulic pressure distributors in the case of hydraulic steering or, finally, in the case of electrical steering, actuates the encoder ring of a sensor device delivering a signal to the electric control motor, various combinations of these types being possible.

In the case of purely electrical steering, increasingly commonly used for handling equipment such as fork-lift trucks, a system for detecting the rotation of the wheel, which may or may not be built into the bearings, delivers, via a cable, a signal representative of the rotation of the wheel and bound for the device for orientating the running wheels of the vehicle. As the wheel is mounted on its support via one or more rolling bearings and is not connected to mechanical torque-transmitting systems, the wheel can be turned with an extremely low resistive torque. A control-wheel braking system is therefore often added in such cases in order to generate in the wheel a resistive torque so as to make the vehicle more accurate and more comfortable to drive. A device of this type is described, for example, in document DE-A-195 10 717.

That device does, however, display certain disadvantages, among which we can note first of all the relatively high axial bulk and the relatively high cost which are due to the presence of two rolling bearings in the prolongation of which a brake system using a coil spring pressing a conical friction piece into a cup also comprising a conical frictional surface is arranged. The frictional torque developed by such a device is relatively low and the wear is great because of the small friction surfaces. Furthermore, the braking system alters the operating clearance of the bearings.

Document FR-A-2 782 970 discloses an operating wheel mounted on an instrumented rolling bearing and to which there is added. a braking system, the rotating part of which is supported by the rotating inner ring of the bearing and rubs against the end of a casing. However, in this type of device, the rolling bearing is not mounted on a shaft and the diametral bulk of the bearing and of the device is great.

Document FR-A-2 810 088 proposes a braked rolling bearing of small radial bulk. The braking means comprises an axial stack of discs kept in frictional contact by at least one axially elastic element with at least one disc angularly secured to the non-rotating part and at least one disc secured to the rotating part. The braking means comprises at least one elastic washer serving to ensure mutual contact with axial preload of the friction surfaces of the discs. This bearing is satisfactory in numerous applications but has a relatively large axial bulk and a high number of parts. Furthermore, a slight circumferential clearance may be produced because of the tolerances of fit of the discs in their support, this circumferential clearance being perceptible to the operator as he changes the direction in which he turns the wheel.

The invention proposes to remedy the disadvantages of the devices of the prior art.

The invention proposes a rigid and axially not too bulky economical device.

The braked rolling bearing device, according to one aspect of the invention, is of the kind intended for a control wheel. The device comprises an outer part and an inner part, one being able to rotate with respect to the other, which does not rotate, by means of at least one row of rolling elements arranged between the said rotating and non-rotating parts. The said device further comprises a means for detecting rotation parameters and a means for braking the rotating part. The braking means comprises a component equipped with flexible tabs bearing against an annular friction member.

The device has a small axial bulk because of the tabs which occupy very little space. The braking means and the member equipped with tabs may be fixed firmly to their respective supports, one rotating and the other non-rotating.

In one embodiment, the tabs are axially flexible.

In another embodiment, the tabs are radially flexible.

In one embodiment, the tabs are arranged in opposing pairs. The braking torque is the same in both directions of rotation.

In one embodiment, the tabs are uniformly distributed about the circumference. Thus, the tabs do not alter the operation of the rolling bearing.

In one embodiment, the member equipped with tabs is push-fitted onto a support of the outer ring, for. example in the bore of a casing.

In another embodiment, the member equipped with tabs is push-fitted onto a shaft secured to the inner ring.

In one embodiment, the member equipped with tabs comprises a push-fit portion and a portion equipped with tabs, one of the portions being axial and the other radial.

In another embodiment, the member equipped with tabs comprises a push-fit portion equipped with tabs.

As a preference, the member equipped with tabs forms a sealing means by way of a narrow passage. The narrow passage may be by itself or supplemented with a seal.

In one embodiment, the annular friction member comprises a support and a friction lining.

In one embodiment, the annular friction member comprises a support mounted axially between a bearing ring and a shoulder of an element secured to the said ring. The friction member may be clamped axially between the said ring and the said shoulder.

In another embodiment, the annular friction member comprises a support push-fitted onto an element secured to a bearing ring.

In another embodiment, the annular friction member comprises a friction lining supported directly by an element secured to a bearing ring. The number of components in the device is therefore further reduced.

In one embodiment, the device comprises a seal protecting the braking means.

In one embodiment, the means for detecting rotation parameters comprises a sensor secured to the non-rotating part and an encoder secured to the rotating part.

In one embodiment, the means for detecting the rotation parameters comprises a sensor mounted in a cover equipped with a wire outlet. The cover performs a dual function of closing and of supporting the sensor.

In one embodiment, the inner ring of the bearing is push-fitted onto a shaft supporting the wheel. The said shaft may be provided with a shoulder extending outwards.

In one embodiment, the outer ring of the bearing is push-fitted into a casing supporting part of the braking means.

The cover may be closed on the end of the casing so as to close off the said casing on the opposite side to the wheel.

The inner ring may be rotating and the outer ring non-rotating, or vice versa.

This braked bearing device is readily adaptable and can easily be mounted in numerous possible locations on a vehicle or a machine, for example on a dashboard, via the casing that forms the support. Just a few screws are needed to fix the device via the casing. The wheel may be used for controlling a vehicle or a machine, more particularly for steering a vehicle.

The present invention will be better understood and other advantages will become apparent from reading the detailed description of a few embodiments taken by way of nonlimiting examples and illustrated by the attached drawings, in which:

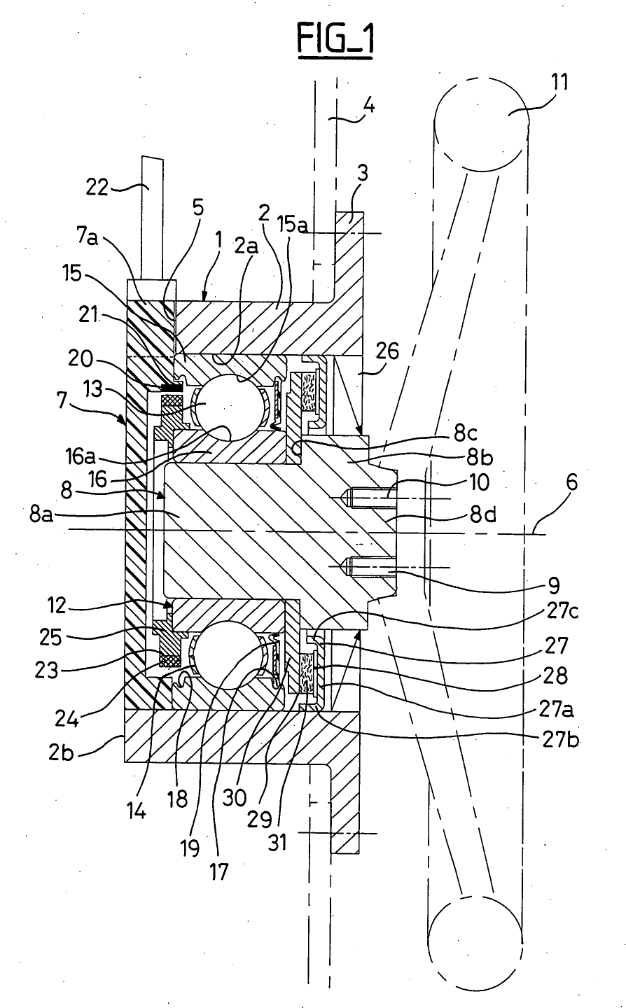

FIG. 1 is a view in axial section of a bearing device according to a first embodiment of the invention;

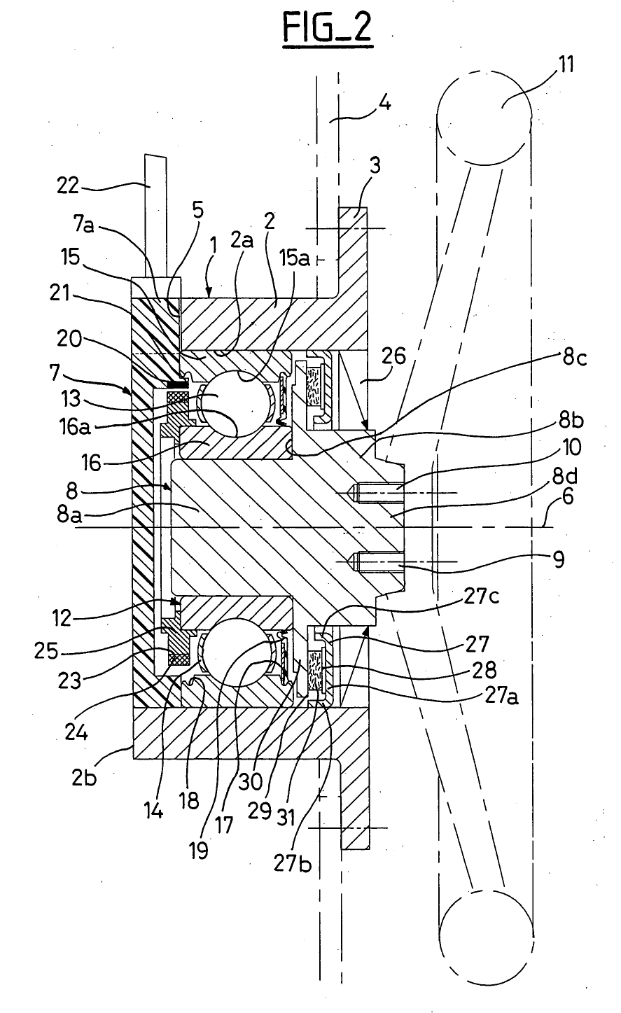

FIG. 2 is a view in axial section of a bearing device according to a second embodiment of the invention;

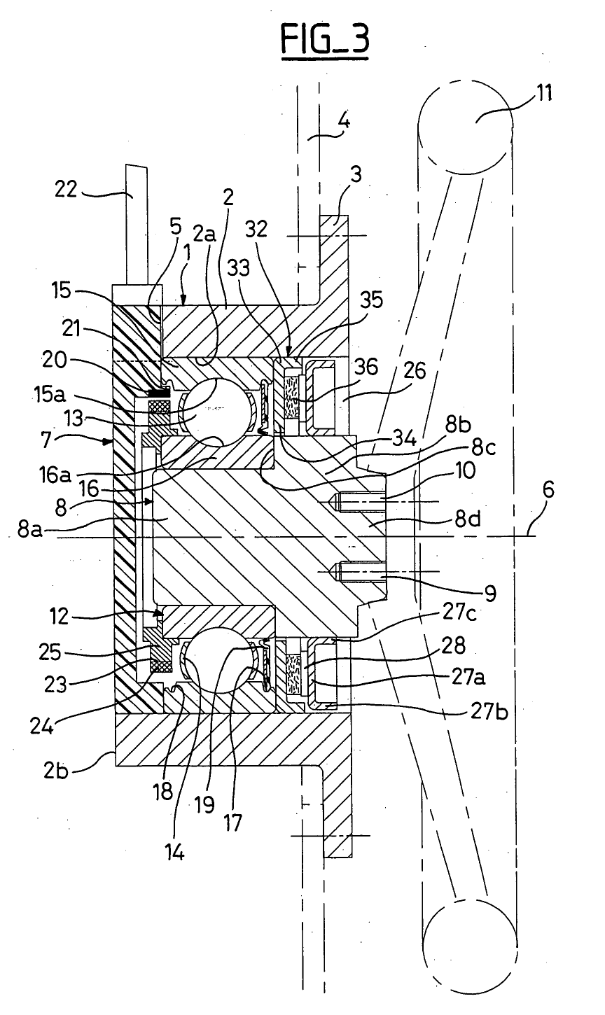

FIG. 3 is a view in axial section of a bearing device according to a third embodiment of the invention;

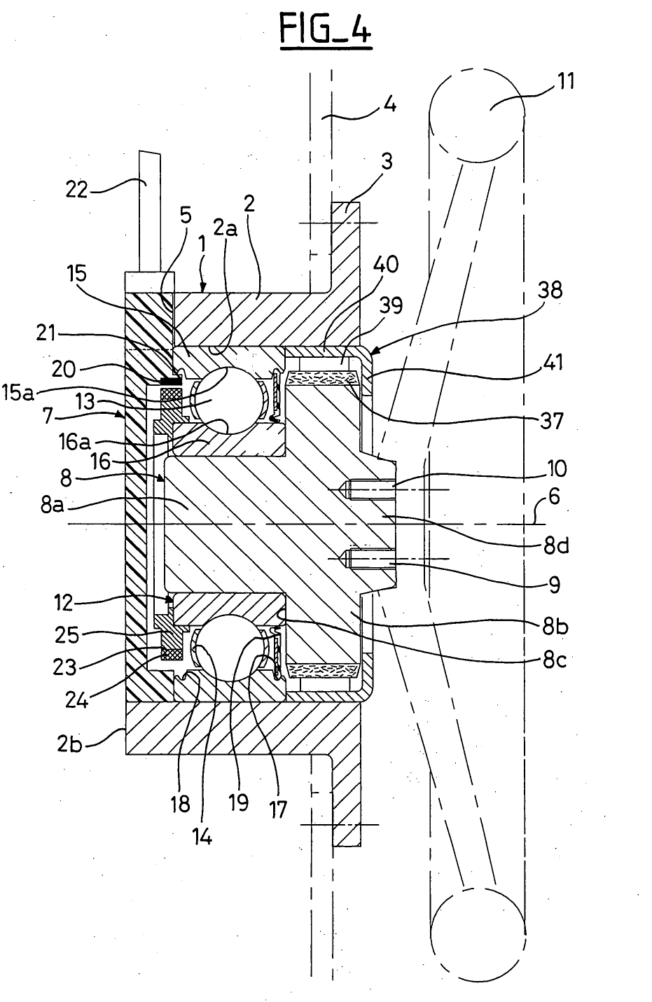

FIG. 4 is a view in axial section of a bearing device according to a fourth embodiment of the invention;

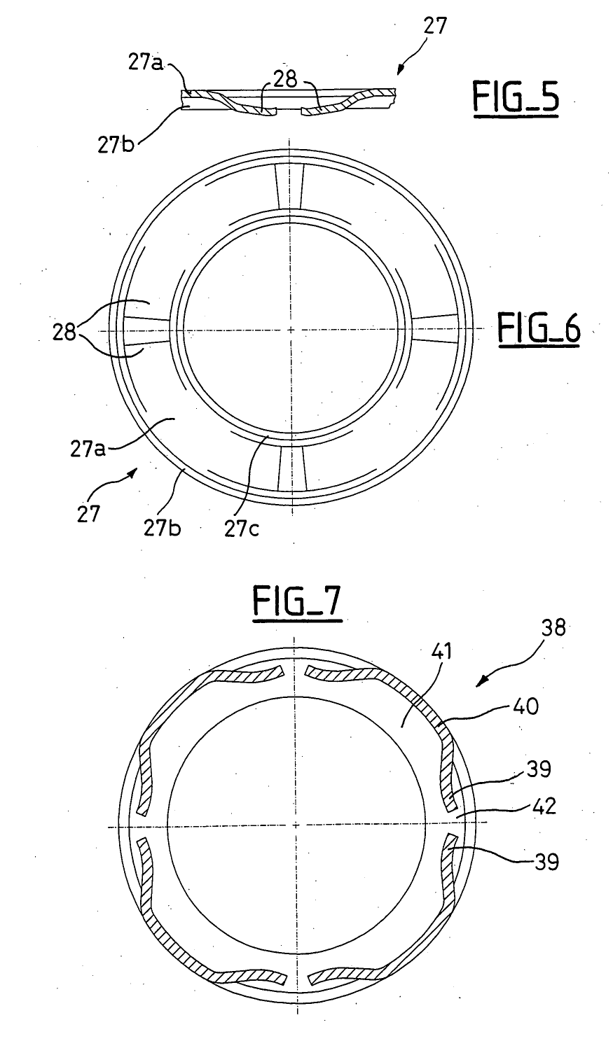

FIG. 5 is a half view in axial section of a member equipped with tabs mounted in the device according to FIGS. 1 and 2;

FIG. 6 is a front elevation of the member of FIG. 5; and

FIG. 7 is a half view in axial section of a member equipped with tabs and mounted in the device according to FIG. 4.

As can be seen in FIGS. 1 to 4, the rolling bearing device comprises an outer casing 1, annular in shape, with an L-shaped half-section, with a tubular portion 2 and a radial portion 3 extending outwards at one end of the tubular portion 2. The radial portion 3 is provided with a plurality of fixing holes able to take screws so as to fix it to a fixed frame 4. The tubular portion 2 is provided with a bore 2a and with a radial end surface 2b situated at the opposite end to the radial portion 3. A notch 5 is formed in the radial end surface 2b. The casing 1 may be made of metal and produced in pressed sheet metal, cast light alloy or sintered, or may alternatively be machined from solid. It may also be made of a material synthetically injection moulded. The casing 1 is centred on an axis 6.

A cap 7, for example made of synthetic material, in the form of a disc, closes the free end of the tubular portion 2 by fitting into its bore 2a and occupying the notch 5. The cap 7 has a wire terminal 7a arranged in the said notch 5.

The rolling bearing device also comprises an inner element 8, centred on the axis 6, of solid cylindrical shape, having a small-diameter portion 8a, a large-diameter portion 8b, these portions being separated by a shoulder 8c, and being arranged in the casing 1, and a protrusion 8d projecting from the radial portion 3 of the casing 1. A plurality of holes 9 are provided through the protrusion 8d to take screws 10, for example intended to fix an operating wheel 11. The inner element 8 may also be made of pressed sheet metal and be hollow.

Arranged between the casing 1 and the inner element 8 is a rolling bearing 12 comprising a row of rolling elements 13 held by a cage 14 and arranged between outer 15 and inner 16 rings. However, provision could be made for the rolling elements to be directly in contact with the casing 1 and the inner element 8 via raceways formed on the casing 1 and the inner element 8.

The outer ring 15 is push-fitted into the bore 2a of the tubular portion 2 of the casing 1 and is provided with a raceway 15a for the rolling elements 13. The inner ring 16 is push-fitted onto the outer surface of the small-diameter portion 8a of the inner element 8 and is provided with a raceway 16a for the rolling elements 13. The outer ring 15 is also provided with two symmetric grooves 17 and 18 formed on its bore, on each side of the raceway 15a. Fixed in the groove 17 is a sealing member 19 which rubs against a land on the inner ring 16 on the opposite side to the cap 7. For economical reasons, it is advantageous for the rolling bearing 12 to be of standard type.

A sensor 20 is supported by the cap 7 by means of a portion 21 which is partially inserted inside the bore of the non-rotating ring 15 more or less at the groove 18. The sensor 20 is connected to a processing unit, not depicted, by wires passing through the wire terminal 7a and leaving the cap 7 radially outwards via the electrical cable 22. The sensor 20 may be of the Hall-effect type.

The detection means is supplemented by an annular encoder 23 supported by the rotating ring 16. The encoder 23, which may for example be of magnetic type, comprises an active part 24, for example in the form of a multi-pole ring, and a support part 25 push-fitted onto an external end of the rotating inner ring 16 until it comes into abutment against a frontal radial surface of the said ring 16. The relative axial position of the encoder 23 and of the sensor 22 is afforded by push-fitting the encoder 23 as far as it will go onto the said ring 16 and by the support of the sensor 20 by the cap 7 itself mounted in axial contact against the frontal radial face of the non-rotating ring 15.

A portion of the encoder 23 thus lies between the rings 15 and 16 and a portion protrudes outwards. The outer cylindrical surface of the encoder 23 lies facing the sensor 20 with a small air gap.

As can be seen in FIGS. 1 and 2, a seal 26 is arranged between the bore 2a of the tubular portion 2 of the casing 1 on the same side as the wheel 11 and the outer surface of the large-diameter portion 8b of the inner element 8.

The braking means is arranged axially between the rolling bearing 12 and the seal 26 and radially between the casing 1 and the inner element 8.

As can be seen in FIG. 1, the braking means comprises a member 27 equipped with flexible tabs 29 and an annular friction member 29. The member 27, made of pressed sheet metal, has an annular shape with a U-shaped cross-section and a radial end 27a, an outer rim 27b push-fitted tightly into the bore 2a of the tubular portion 2 of the casing 1, and an inner rim 27c a short radial distance away from the outer surface of the large-diameter portion 8b of the inner element 8. The free ends of the rims 27b and 27c are directed towards the rolling bearing 12. A plurality of tabs 28 are formed by partial cutting of the radial end 27a and project axially between the rims 27b and 27c towards the rolling bearing 12. The tabs 28 here are eight in number, in four pairs uniformly distributed about the circumference, see FIGS. 5 and 6. The free ends of the tabs 28 of one pair face each other, while maintaining a distance between them so that they do not interfere, see also FIG. 6.

The annular friction member 29 comprises a support ring 30 and a brake lining 31 made of a material with a high coefficient of friction with respect to the surface of the tabs 28. The support ring 30 has the shape of a radial washer and is clamped on the inside between the shoulder 8c and the corresponding radial frontal face of the inner ring 16. The bore of the ring 30 corresponds to the outside diameter of the small-diameter portion 8a of the inner element 8, thus preventing any clearance both radial and axial. The brake lining 31 is fixed on the radial surface of the ring 30 directed towards the wheel 11 on the outside. The tabs 28 rest against the brake lining 31.

The device thus obtained contains a small number of components, the braking means comprising just two of these, leading to a low sourcing and mounting cost. The circumferential clearance of the braking means is non-existent when the wheel changes direction of rotation because of the rigid attachment of the annular friction member 29 and of the member 27. The radial bulk of the braking means is similar to that of the rolling bearing. The axial bulk of the braking means is very small, markedly smaller than that of the rolling bearing. The direct contact between the tabs and the brake lining allows a reduction in the bulk and in the number of components.

The braking torque is determined by the stiffness and degree of bending of the tabs. Arranging the tabs in opposing pairs, symmetrically with respect to a radius, makes it possible to maintain a torque that is strictly constant in both directions of rotation.

In the embodiment illustrated in FIG. 2, the device is similar to the one illustrated in FIG. 1, except that the support ring 30 of the annular friction member 29 is of one piece with the inner element 8, being formed between the small-diameter portion 8a onto which the inner ring 16 of the rolling bearing 12 is push-fitted and the large-diameter portion 8b.

In the embodiment illustrated in FIG. 3, the device is similar to the one illustrated in FIG. 1 except that the inner ring 16 of the bearing 12 comes into contact via its radial frontal face directed towards the wheel 11 with the shoulder 8c of the inner element 8. The member 27 equipped with flexible tabs 28 is provided with rims 27b and 27c directed away from the bearing 12 towards the wheel 11, the tabs 28 projecting away from the said rims 27b and 27c. No additional seal is provided in the space that remains between the member 27 and the radial end face of the casing 1 in the direction of the wheel 11.

The annular friction member 32 comprises a support cup 33 provided with a radial portion 34 and with an axial rim 35, and a seal 36. The axial rim 35 is push-fitted into the bore 2a of the tubular portion 2 of the casing 1. The radial portion 34 is directed inwards from the axial rim 35, its free end being arranged a short distance away from the outer cylindrical surface of the large-diameter portion 8b of the inner element 8. The radial portion 34 is in contact with the radial frontal surface of the outer ring 15 of the bearing 12, on the opposite side to the cap 7. The seal 36 is fixed, for example by bonding or by overmoulding, to the radial portion 34, on the opposite side to the bearing 12, and therefore on the side of the tabs 28 of the member 27. The seal 36 is positioned radially more or less mid-way between the bore 2a of the tubular portion 2 of the casing 1 and the cylindrical outer surface of the large-diameter portion 8b of the inner element 8 so as to avoid interference between the tabs 28 and the axial rim 35.

The annular friction member 32 is, once again, an element of simple shape, economical to manufacture, it being possible for the support to be manufactured from a piece of sheet metal. The braking means consists merely in two elements that are economical to manufacture and have satisfactory axial and radial compactness.

In the embodiment illustrated in FIG. 4, the seal 37 is fixed directly to the cylindrical and outer surface of the large-diameter portion 8b of the inner element 8. In this case, provision may be made for the said large-diameter portion 8b to have an outside diameter that is no longer more or less equal to that of the inner ring 16 of the bearing 12, as it was in the previous embodiments, thus making it possible to maintain enough radial space to house the braking means in. The large-diameter portion 8b here extends radially between the inner 16 and outer 15 rings as far as the vicinity of the bore of the outer ring 15. The seal 37 is formed over the entire axial length of the large-diameter portion 8b and runs radially outwards over a thickness of a few millimetres.

The braking means is supplemented by a member 38 equipped with tabs 39. The member 38 has the shape of a cup with an L-shaped cross-section with an axial portion 40 push-fitted into the bore 2a of the tubular portion 2 of the casing 1 with its free end in contact with the frontal radial surface of the outer ring 15 of the bearing 12, on the opposite side to the cap 7, and a radial portion 41 arranged at the opposite end of the axial portion 40 to the bearing 12 and extending radially inwards, over a short distance covering the large-diameter portion 8b of the inner element 8 to form therewith a seal by way of a narrow passage. The tabs 39 are formed by partial cutting in the axial portion 40 and extend radially inwards until they come into contact with the seal 37. Contact is designed to be with a certain preload, the value of which determines the frictional torque thus created.

In other words, the member 38 provides both a sealing function and a friction surface for the seal. As the seal 37 is supported by the inner element, the number of components independent of the braking means is limited to just the member 38. This embodiment is particularly compact radially in that the braking means occupies an extremely small radial space, much smaller than the space occupied by the rolling bearing 12.

The geometric configuration of the tabs 39, see FIG. 7, is similar to the other embodiments in that the tabs 39 are uniformly distributed around the circumference in several pairs of tabs, in this instance in four pairs of tabs, the free ends of which face each other to ensure a torque that is constant in both directions of rotation and uniform wear of the seal and a radial preload that is evenly distributed.

Advantageously, the free ends of the tabs 39 of one pair of tabs facing each other are separated by a space 42 preventing them from interfering with each other. Furthermore, the free ends of the tabs 39 are curved slightly outwards, contrary to the overall shape of the said tabs, so as to avoid the said free ends of the tabs 39 seizing on the outer surface of the seal 37. The tabs 39 thus offer a rounded convex surface for rubbing on the seal 37.

In this last embodiment, the frictional torque is obtained by construction. The axial position of the member 38 with tabs 39 does not influence the frictional torque. It may also be pointed out that the radial action of the tabs 39 does not place the bearing 12 under any internal axial preload.

In general, the device offers great stability of torque regardless of the direction of rotation, absence of clearance in the circumferential direction when changing the direction in which the wheel is turned, extreme simplicity of assembly with just one or two components to be mounted by simple push-fitting onto the surrounding components, and great axial and radial compactness thanks to the low number of components and their simple shape. The modular design of the braking means makes it easy to modify the frictional torque by changing the member with tabs, it being possible for this to be done without varying the axial bulk of the device, thanks to the small thickness of the components.

1. Braked rolling bearing device of the type for a control wheel, comprising an outer part and an inner part, one being able to rotate with respect to the other, which does not rotate, by means of at least one row of rolling elements arranged between the said rotating and non-rotating parts, the said device further comprising a means for detecting rotation parameters, a means for braking the rotating part, and an annular friction member, the braking means comprising at least one component equipped with flexible tabs bearing against the annular friction member.

2. Device according to claim 1, wherein the tabs are axially flexible.

3. Device according to claim 1, wherein the tabs are radially flexible.

4. Device according to claim 1, wherein the tabs are arranged in opposing pairs.

5. Device according to claim 1, wherein the tabs are uniformly distributed about the circumference.

6. Device according to claim 1, wherein the member equipped with tabs is push-fitted onto a support of the outer ring.

7. Device according to claim 1, wherein in that the member equipped with tabs is push-fitted onto a shaft secured to the inner ring.

8. Device according to claim 1, wherein in that the member equipped with tabs comprises a push-fit portion and a portion equipped with tabs, one of the portions being axial and the other radial.

9. Device according to claim 1, wherein the member equipped with tabs comprises a push-fit portion equipped with tabs.

10. Device according to claim 1, wherein the member equipped with tabs forms a sealing means by way of a narrow passage.

11. Device according to claim 1, wherein the annular friction member comprises a support and a friction lining.

12. Device according to claim 1, wherein the annular friction member comprises a support mounted axially between a bearing ring and a shoulder of an element secured to the said ring.

13. Device according to claim 1, wherein the annular friction member comprises a support push-fitted onto an element secured to a bearing ring.

14. Device according to claim 1, wherein the annular friction member comprises a friction lining supported directly by an element secured to a bearing ring.

15. Device according to claim 1, wherein it comprises a seal protecting the braking means.

16. Device according to claim 1, wherein the means for detecting rotation parameters comprises a sensor secured to the non-rotating part and an encoder secured to the rotating part.

17. Device according to claim 1, wherein the means for detecting the rotation parameters comprises a sensor mounted in a cover equipped with a wire outlet.

18. Device according to claim 1, wherein the inner ring of the bearing is push-fitted onto a shaft supporting the wheel.

19. Device according to claim 18, wherein the said shaft is provided with a shoulder extending outwards.

20. Device according to claim 1, wherein the outer ring of the bearing is push-fitted into a casing supporting part of the braking means.

21. Device according to claim 1, wherein the cover is fixed onto the end of the casing so as to close off the said casing on the opposite side to the wheel.

22. Braked rolling bearing device for a wheel, said device comprising an outer part, an inner part, one of the outer part and inner part being able to rotate with respect to the other part, at least one row of rolling elements arranged between the said rotating and non-rotating parts, a rotation parameters detector, a brake for braking the rotating part, and an annular friction member, said brake comprising at least one component equipped with flexible tabs bearing against the annular friction member.

23. Braked rolling bearing device for a wheel, said device comprising an outer part, an inner part, at least one row of rolling elements arranged between the said outer and inner parts so that one of the outer part and inner part be able to rotate with respect to the other part, a rotation parameters sensor, an annular friction member, and a brake for braking the rotating part, said brake comprising flexible tabs bearing against the annular friction member.
